(19) United States
(12) Patent Application Publication
(10) Pub. No.: US 2025/0378501 A1
(43) Pub. Date: Dec. 11, 2025

(54) STATE DETECTOR SYSTEM AND METHOD

(71) Applicant: QuadreTech, LLC, Austin, TX (US)

(72) Inventor: Thomas Lloyd LeBleu, Suwanee, GA (US)

(73) Assignee: QuadreTech, LLC, Austin, TX (US)

(21) Appl. No.: 19/229,369

(22) Filed: Jun. 5, 2025

Related U.S. Application Data
(60) Provisional application No. 63/657,439, filed on Jun. 7, 2024.

(51) Int. Cl. G06Q 40/06

(52) U.S. Cl. CPC G06Q 40/063

(57) ABSTRACT

A state detection system includes a processor and memory communicatively connected to the processor. The memory includes instructions for controlling the processor to obtain raw data of annuity products, write the raw data to a rules table of respective files communicatively connected to the processor, select one or more of the respective files corresponding to a request, build a vector comprised of the one or more respective files, each annuity product exhibited by the one or more respective files is a respective policy instance, calculate a respective cash value and a respective surrender value of each respective policy instance of the vector based on the raw data, calculate a projected cash value and a projected surrender value for each respective policy instance of the vector, and match the respective policy instance to the request based on the respective cash value, the respective surrender value, the projected respective cash value, and the projected respective surrender value, and calculate a duration for the respective policy instance so matched.

### CROSS-REFERENCE TO RELATED APPLICATION

The present application is a conversion of and has benefit of priority of the following application, which is co-pending and has at least one same inventor of the present application: U.S. Provisional Patent Application No. 63/657,439, titled “State Detector System and Method”, filed Jun. 7, 2024.

### TECHNICAL FIELD

The present disclosure relates generally to termination dates of annuities, and more particularly, relates to a computer and network implemented state detector for multi-year guaranteed annuities (MYGA).

### BACKGROUND

Annuities are properties of their owners. These properties (also referred to as “annuity products”) each have a value from time to time. The value is determined by the rate of growth of the annuity at each point in time throughout time remaining for the growth. At any particular specified point in time, however, a then current (or otherwise specified dated) value of the property may not be readily available.

Moreover, owners of annuity properties may determine to surrender the property under certain circumstances, such as if growth rates are less than market or otherwise. These properties generally require a surrender charge. The surrender charge may itself have a termination.

Some annuity properties terminate specified growth at specific time. Other annuity properties renew or newly continue a newly specified growth at specific time(s). Those specific times of termination and/or renewal may not generally be knowable with certainty.

Information about annuities is available from, for example, the Depository Trust & Clearing Corporation (DTCC). Each annuity has a unique CUSIP number associated with the specific annuity. The CUSIP number uniquely identifies equity, debt, and other securities, including annuities, registered in the United States and Canada. Annuities are therefore uniquely identifiable by CUSIP number. Although some information about annuities is available from DTCC, termination and renewal dates and other information is not available on a timely basis in many instances.

Two types of multi-year guaranteed annuities (MYGAs), in particular, either terminate or automatically renew at particular dates. The termination or renewal date, as applicable, may not be available in information from a source such as DTCC. Carriers that source the MYGA products often do not make available such information, because the carriers may be able to retain amounts paid for the products whether terminated or renewed.

The first type of MYGA—fixed term—is subject to remaining in limbo (i.e., a “zombie,” “zombie limbo,” “limbo,” or “zombie policy”) with the carrier on termination of the fixed term. Although withdrawal is an option to the owner, this is often overlooked and the corpus of the resulting amount for the annuity may be rolled over by the carrier to a low or market growth rate investment. Surrender charges drop off and the crediting rate for the corpus often changes from the guaranteed rate of the fixed term.

The second type of MYGA—automatic renewal—is subject to rollover by the carrier to a new MYGA, with new rate, new surrender charge schedule, and other terms upon expiration of the current term. When a MYGA is rolled over automatically, the MYGA will have a new growth rate and surrender charge will be also newly reinstated based on the value of the MYGA at the time of renewal. Consequently, the surrender charge will continue with a diminishing schedule that is based on the then current value (not the original value) of the annuity at the time of renewal.

Thus, detailed information of both the first type of MYGA in limbo and the second type of MYGA with autorenewal is not generally available. Such information, however, is valuable to annuity property owners and investment providers, such as insurance carriers and securities sellers.

It would therefore be advantageous to provide systems and methods for determining an annuity value and termination or renewal. It would be further advantageous to provide termination and renewal detection systems and methods that would give knowledge of annuity provider sources. It would further be an advantage to automate such systems and methods for communicative availability over a data communications network.

### SUMMARY

An embodiment of the invention is a system. The system includes a processor and memory communicatively connected to the processor. The memory includes instructions for controlling the processor to obtain raw data of annuity products, write the raw data to a rules table of respective files communicatively connected to the processor, select one or more of the respective files of the rules table corresponding to a request, build a vector comprised of the one or more of the respective files, each annuity product exhibited by the one or more respective files is a respective policy instance, calculate a respective cash value and a respective surrender value of each of the respective policy instance of the vector based on the raw data, calculate a projected respective cash value and a projected respective surrender value for each of the respective policy instance of the vector, match any of the respective policy instance to the request based on the respective cash value, the respective surrender value, the projected respective cash value, and the projected respective surrender value, and calculate a duration for any of the respective policy instance matched in the match.

Another embodiment of the invention is a method. The method includes obtaining raw data of annuity products, writing the raw data to a rules table of respective files, selecting one or more of the respective files of the rules table, building a vector of the one or more of the respective files, each annuity product exhibited by the one or more respective files is a respective policy instance, calculating a respective cash value and a respective surrender value of each of the respective policy instance of the vector based on the raw data, calculating a projected respective cash value and a projected respective surrender value for each of the respective policy instance of the vector, matching any of the respective policy instance to the request based on the respective cash value, the respective surrender value, the projected respective cash value, and the projected respective surrender value, and calculating a duration for any of the respective policy instance matched in the match.

### BRIEF DESCRIPTION OF THE DRAWINGS

The present invention is illustrated by way of example and not limitation in the accompanying figures, in which like references indicate similar elements, and in which:

FIG. 1 illustrates a system for detecting a state of an annuity product, according to certain embodiments of the invention;

FIG. 2 illustrates an application unit of the system of FIG. 1, according to certain embodiments of the invention;

FIG. 3 illustrates a rules table of the system of FIG. 1, according to certain embodiments of the invention;

FIG. 4 illustrates a method for detecting a state of an annuity product, according to certain embodiments of the invention;

FIG. 5 illustrates a method for building a vector of policy instances for annuity products, according to certain embodiments of the invention; and

FIG. 6 illustrates a method for determining a duration of an annuity product, according to certain embodiments of the invention.

### DETAILED DESCRIPTION

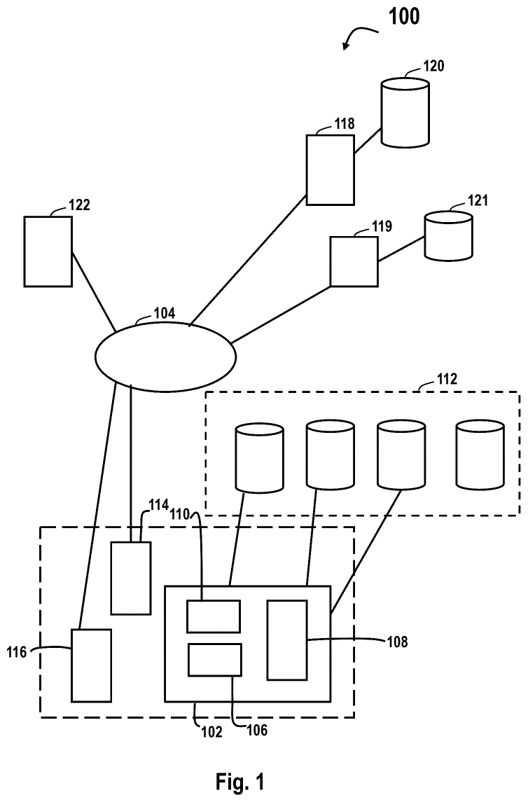

Referring to FIG. 1, a nonexclusive embodiment of a system 100 includes a processing device 102 communicatively connected to a data communications network 104. The processing device 102 includes a processor 106 communicatively connected to memory 108. An application unit 110 is included in the processing device 102, or otherwise communicatively accessible to the processor 106.

The processing device 102 includes one or more computer systems including one or more of the processor 106, the memory 108, and a system bus (not shown in detail) that couples system components, including the memory 108, to the processor 106. The memory 108 may, for nonexclusive example, include a read only memory (ROM) and a random access memory (RAM). A basic input/output system (BIOS) containing the basic routines that help to transfer information between elements within the computer system is stored in the ROM.

The processing device 102 may also, in nonexclusive example, include one or more of a storage drive 112. The processing device 102 may also, in nonexclusive example, include one or more input peripheral device and output peripheral device (not shown in detail). The storage drive 112 and the peripheral devices are connected to the system bus by relevant interface. A number of modules can be stored in the memory 108 or storage drive 112, including, for nonexclusive example, an operating system and the application unit 110. The processing device 102 also includes or communicatively connects to a collector 114 and a reporter 116, each communicatively connected to the communications network 104 by applicable interface devices for receiving and sending data over the communications network 104.

The processing device 102 may, as non-exclusive example, be or include one or more server computer communicatively connected to the network 104 for processing software modules stored in memory, controlling interconnected hardware elements, and combinations of these, specially configured to provide operations and services later described. Although the processing device 102 is illustrated as a single device, the processing device 102 could be a distributed processing or computing system comprising more than one server or computing device. The processing device 102 may, for non-exclusive example, be or include a cloud server.

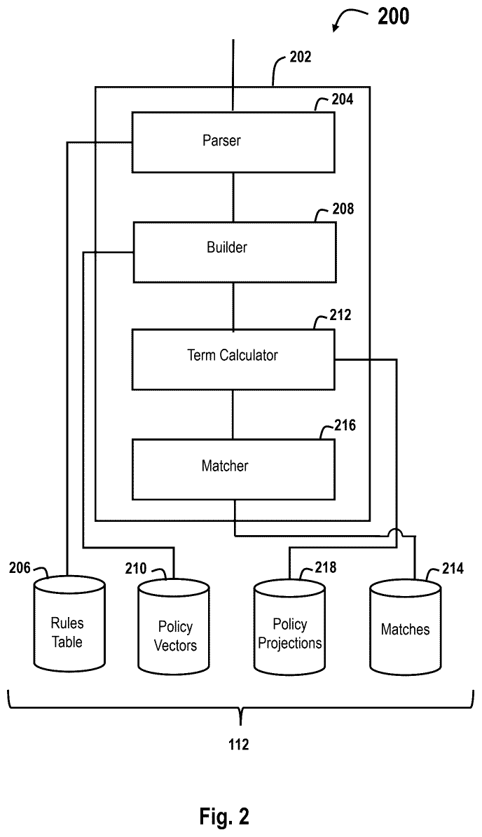

A client device 122 may, in certain nonexclusive embodiments, communicatively connect to the system 100 via the network 104. The client device 122, for nonexclusive example, is a processing device capable of data communications on the network 104, such as a computer, smart phone, tablet, or other. The client device 122 can make a request to the system 100 for one or more particular annuity product of interest, based on one or more annuity attribute of interest (such as, for nonexclusive example, duration, current value, and surrender value, which as later described, corresponds to a file/category of a rules table 206 of FIG. 2). Although the client device 122 is illustrated as a separate communications device communicating over the network 104, the client device 122 may be integral to or otherwise communicative with the system 100, for nonexclusive example, the client device 122 could be an input peripheral device to the processing device 102 of the system 100.

Referring to FIG. 2, in conjunction with FIG. 1, an embodiment 200 of the application unit 110 of FIG. 1, includes one or more control module 202. The control module 202 is included in or communicatively connects to the processor 106 of FIG. 1, to control the processor 106 in combination with the memory 108 and the storage drive 112. The control module 202 includes or communicatively connects to one or more of each of a parser 204, a builder 208, a calculator 212, and a matcher 216. In certain non-exclusive embodiments, the control module 202 or portions thereof is implemented in software stored in memory, application specific processor, logic circuits, or combinations of these or other devices. The control module 202 may be one or more discrete units or modules.

The parser 204 receives raw data (herein so called) of annuity products, such as for non-exclusive example, from a server computer 118, such as a server computer operated by Depository Trust & Clearing Corporation (DTCC), and a memory 120 communicatively connected to the server computer 118. The collector 114 may in certain nonexclusive embodiments access the server computer 118 over the network 104. In other embodiments, the collector 114 may receive the raw data from an input peripheral or other input to the system 100.

The server computer 118 is, for non-exclusive example, one or more computer or communicative device capable of communicating over the network 104 with the processor 106. The server computer 118 and memory 120 make available for access on the network 104 various raw data of annuity products (such as annuity attributes of duration, band, and state of issuance for each separate annuity product, respectively). The DTCC is a centralized clearing authority for most U.S. sourced annuities, as well as other annuities. Each annuity is characterized by specific policy/product identifier and current value (CUSIP), unique to the particular annuity. The parser 204 proceeds through each CUSIP and matches the CUSIP to a respective system identifier 205 unique to the particular annuity product and CUSIP for the system 100.

The parser 204 may also receive further data of annuity policies, such as for non-exclusive example, from another server computer 119, such as a server computer operated by Beacon Research, and a memory 121 communicatively connected to the server computer 119. The parser 204 determines the raw data as annuity attributes of at least duration, band, and state of issuance, for each annuity product available from the server computer 118 and/or the server computer 119. Although two such server computers are illustrated, it should be understood that one or multiple sources of similar raw data of annuity products may be accessed via the system 100. In alternatives, the raw data is input, such as for example, to an input peripheral or other input to the system 100, via the collector 114.

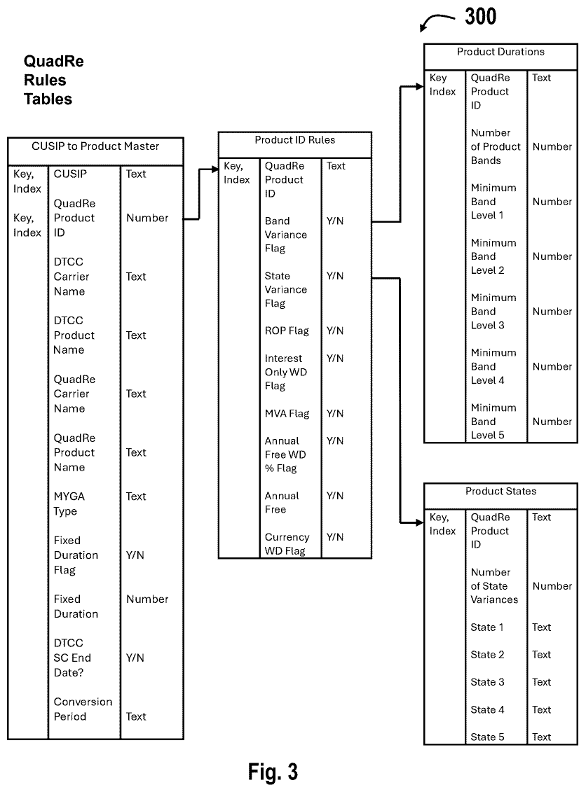

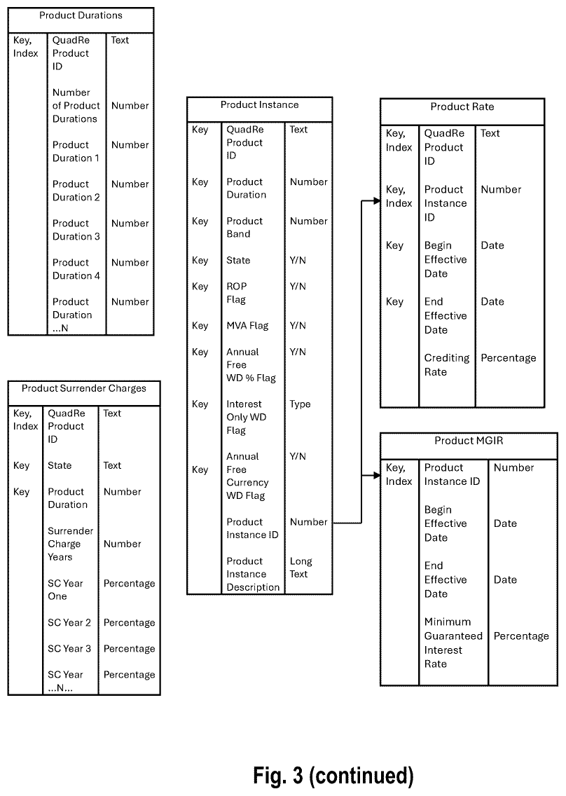

Referring to FIG. 3, in conjunction with FIGS. 1 and 2, the parser 204 communicatively connects to the rules table 206. The rules table 206 may be a database or other schema 300 implemented in the memory 108 and/or storage drive 112, or otherwise implemented in manner communicatively connected to the processor 106. The parser 204 controls the processor 106, operating in conjunction with the memory 108, to map the CUSIP to the rules table 206 by unique system identifier 205 and any other source of data available to the parser 204, such as for example from the server computer 119. The rules table 206 may be one or more (e.g., a series) table for containing the policy attributes of the matched CUSIP identified by the identifier 205 in the system 100.

The rules table 206 will therefore retain annuity attributes in respective files 208 of the table 206. These files 208 of annuity attributes, in particular for multi-year guaranteed annuities (MYGA), including fixed MYGA annuities and automatically renewing MYGA annuities, can typically lack particular current and surrender values and termination dates. The system 100 calculates and assesses missing values and matches these annuities to their source/issuer, notwithstanding the lack of those particular values and dates in the raw data from the other sources (such as the server (e.g., DTCC) 118 or the server (e.g., Beacon) 119). In particular, the system 100 transforms the available annuity attributes from these other sources, such as the server computers 118, 119, to yield current value on specific date; whether there is a surrender charge; if so, how much on the specific date; when will surrender charge go away; whether the annuity will automatically renew; and if so, when will the annuity automatically renew.

The parser 204 communicatively connects to the builder 208. The builder 208 composes a respective vector (e.g., an array) corresponding to each annuity product contained in the rules table 206 that could potentially include an annuity product relevant to a search request of the client device 122 delivered to the system 100 via the network 104, or else otherwise delivered to the system 100. Each vector so composed includes all annuity products that could be relevant, and their respective annuity attributes that are available in the raw data.

Once this vector for an annuity is composed, the builder 208 then eliminates from the vector any of the annuity products that could not apply for the request. The builder 208 eliminates, for nonexclusive example, any wrong state, duration already set, market value adjustment (MVA) flag set, zombie policy status which removes some durations, and distributed product shelf limitations. The builder 208 saves the vector, with eliminations, in a vector storage 210 communicatively connected to the builder 208. The vector is then employed for projections by a calculator 212. Although the policy vector is referred to as such, the vector may be an array or other schema in memory 108 or storage 112.

The calculator 212 is communicatively connected to the builder 208 to receive the vector (with inapplicable products eliminated) from the builder 208. With the vector, the calculator 212 computes projections of duration (if not available in the vector), cash value, surrender value, and surrender charge for each annuity product of the vector. The calculator 212 is communicatively connected to a projections storage 218. The computed projections of the calculator 212 are saved in the storage 218.

The computed projections of the calculator 212 are communicatively delivered to the matcher 216. The matcher 216 compares the vector from the builder, together with the computed projections, to derive a particular vector(s) (i.e., one or more particular annuity product) that are possible match for the request. In short, the vector, together with the computed projections, is proxy of a particular annuity product(s). As proxy, the particular annuity product(s) and annuity provider(s) as well as other annuity product details, including the computed projections of duration, cash value, surrender value, and surrender charge, is made available as results by the system 100.

The system 100 may deliver results to the client device 122 via the network 104, or otherwise delivers results as output of the system 100.

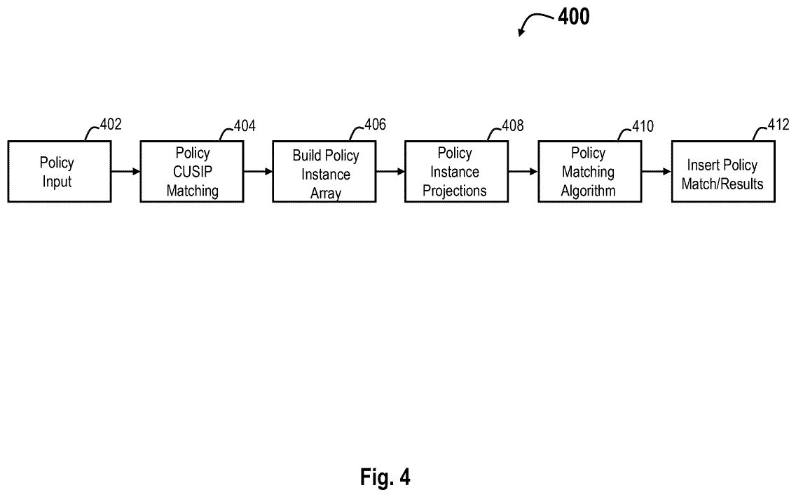

Referring to FIG. 4, in conjunction with FIGS. 1-3, in operation, the system 100 performs a method 400 commencing with receiving 402 annuity attributes for annuity products, such as from the DTCC server 118, by the parser 204. The annuity attributes for each annuity product include a unique CUSIP number and an issue date. The CUSIP is matched 404 to an identifier employed by the system 100. For each annuity product, annuity attributes are stored in the rules table 400.

On the system 100 receiving a request, such as from the client device 122 over the network 104 or otherwise, a vector is built 406. The building 406 includes selection of all annuity products and corresponding annuity attributes that might be relevant. The building 406 then removes those annuity products that have annuity attributes that could not be applicable to the request, such as for nonexclusive example, eliminations are made for wrong state of issue, duration already set, MVA flag set, zombie policy status which removes some durations, and distributed product shelf limitations. The vector from building 406 is delivered to the calculator 212.

For nonexclusive example, the duration, cash value, surrender value and surrender charge for MYGA annuity policies may not be immediately knowable from the raw data. The system 100 then calculates 408 projections for the missing annuity attributes of those annuity products of the vector. In particular, projections are made for at least duration, cash value, surrender value, and surrender charge for each annuity property.

Thereafter, matching 410 is performed by the system 100 to identify one or more specific annuity product that, with relevant annuity attributes, could apply for the request. In the matching 410, comparison is made of the projections from the calculating 408 to obtain a particular one or more annuity product with annuity attributes, respectively, of the vector. Matching 410 also determines (or seeks to do so) the issuer of those particular one or more annuity product.

If match 410 is found, the system 100 reports 412 the result.

### Building the Vector

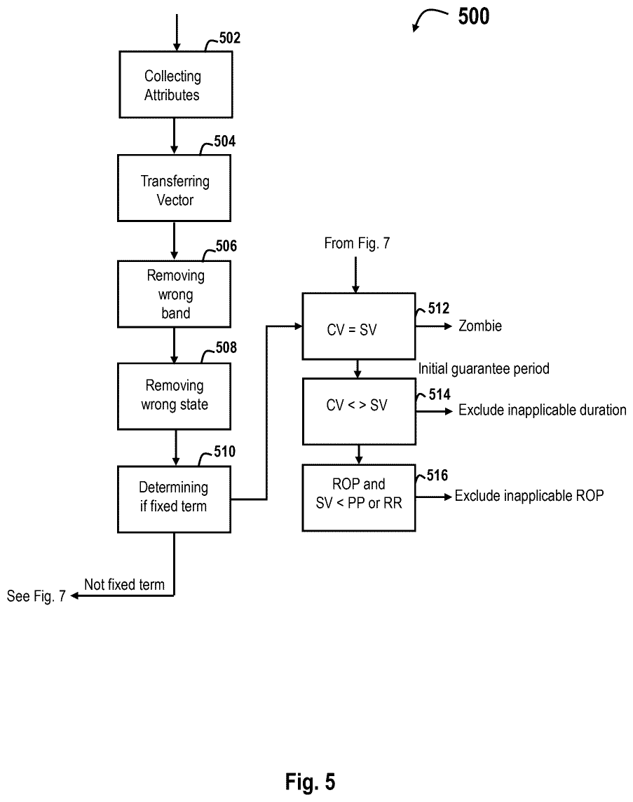

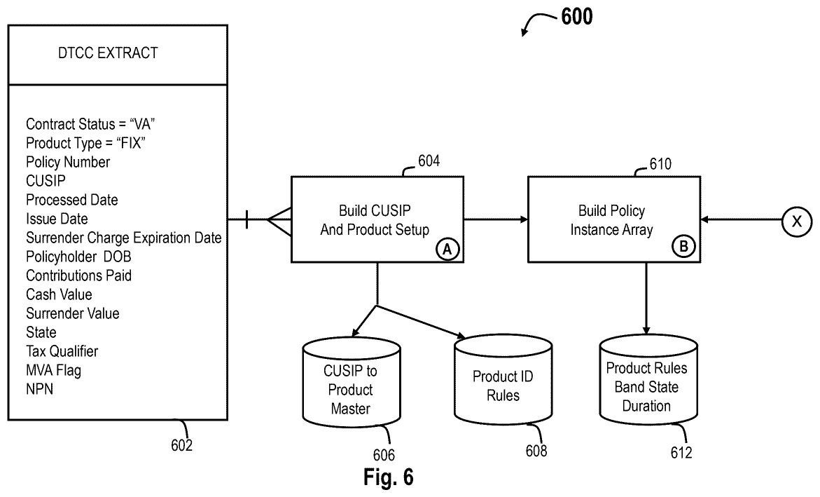

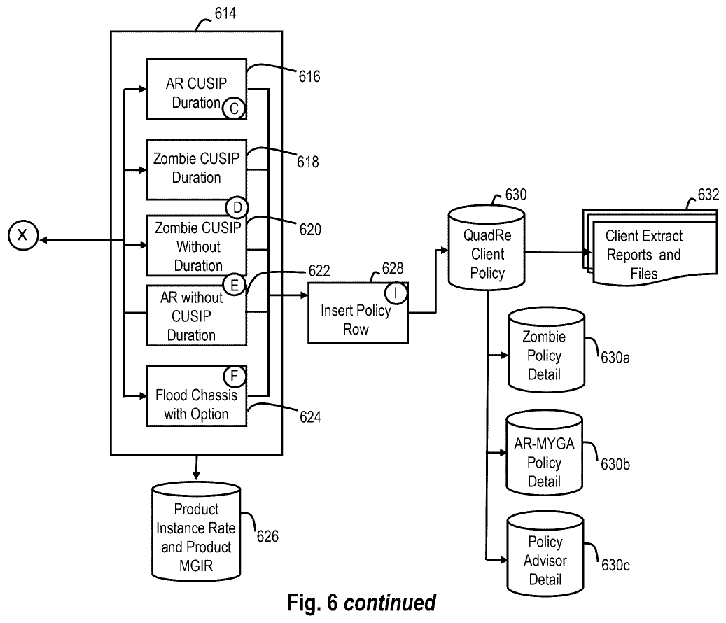

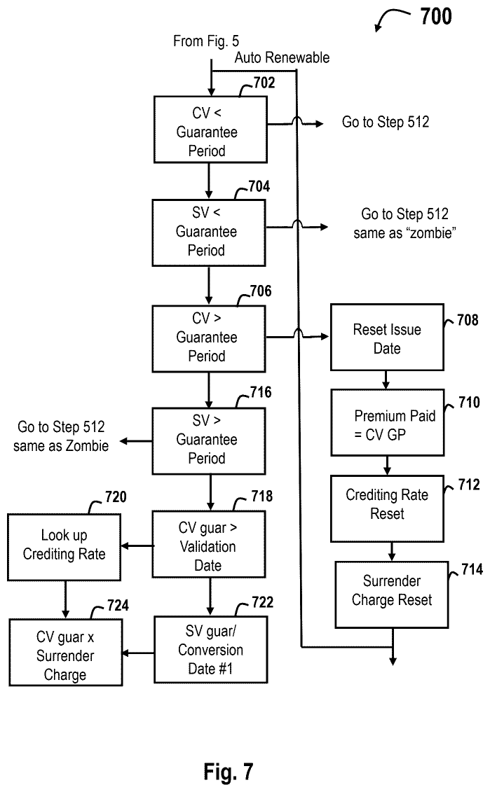

Referring to FIG. 5, in conjunction with FIGS. 1-4, initially, the vector building method 500 by the builder 208 represents all possible annuity products and their annuity attributes (i.e., each a “policy instance” and collectively the “policy instances”) that could have been issued at a specified date of interest corresponding to the search request of category/file of the rules table 206.

A MYGA, and consequently its rate or value, can vary by the following factors:
Policy Duration
Product Band
Product State of Issue
Whether the policy has a Market Value Adjustment (MVA)
Whether the policy has a Return of Premium (ROP) option
Whether the policy allows an annual free withdrawal of cash value (up to a maximum fixed percent)
Whether the policy allows a withdrawal of accumulated interest (only) from cash value

For nonexclusive example, a request may correspond to a particular issue date for the annuity product of interest. In the example, a Delaware Life Pinnacle Plus annuity product has annuity attributes that can vary by duration (3/5/7/10 years), Band (Low, Medium, High), and State (California versus every other state/Default). All policy instances have a market value adjustment (MVA). Therefore, there are 24 possible policy instances for the time of issue—4 durations, 3 bands, and two state variances, creates 4×3×2 or 24 unique combinations of possible policy instances for the relevant annuity product.

In the example, all possible policy instances may as example include:

| QuadRe | Product | Product | Product State | |
|---|---|---|---|---|
| Product ID | Duration | Band | Rate Flag | Product Instance Description |
| DEL86680A285 | 3 | LOW | DEF | Pinnacle Plus MYGA 3 Year Low Band |
| DEL86680A285 | 5 | LOW | DEF | Pinnacle Plus MYGA 5 Year Low Band |
| DEL86680A285 | 7 | LOW | DEF | Pinnacle Plus MYGA 7 Year Low Band |
| DEL86680A285 | 10 | LOW | DEF | Pinnacle Plus MYGA 10 Year Low Band |
| DEL86680A285 | 3 | MEDIUM | DEF | Pinnacle Plus MYGA 3 Year Medium Band |
| DEL86680A285 | 5 | MEDIUM | DEF | Pinnacle Plus MYGA 5 Year Medium Band |
| DEL86680A285 | 7 | MEDIUM | DEF | Pinnacle Plus MYGA 7 Year Medium Band |
| DEL86680A285 | 10 | MEDIUM | DEF | Pinnacle Plus MYGA 10 Year Medium Band |
| DEL86680A285 | 3 | HIGH | DEF | Pinnacle Plus MYGA 3 Year High Band |
| DEL86680A285 | 5 | HIGH | DEF | Pinnacle Plus MYGA 5 Year High Band |
| DEL86680A285 | 7 | HIGH | DER | Pinnacle Plus MYGA 7 Year High Band |
| DEL86680A285 | 10 | HIGH | DEF | Pinnacle Plus MYGA 10 Year High Band |
| DEL86680A285 | 3 | LOW | CA | Pinnacle Plus MYGA 3 Year Low Band CA |
| DEL86680A285 | 5 | LOW | CA | Pinnacle Plus MYGA 5 Year Low Band CA |
| DEL86680A285 | 7 | LOW | CA | Pinnacle Plus MYGA 7 Year Low Band CA |
| DEL86680A285 | 10 | LOW | CA | Pinnacle Plus MYGA 10 Year Low Band CA |
| DEL86680A285 | 3 | MEDIUM | CA | Pinnacle Plus MYGA 3 Year Medium Band CA |
| DEL86680A285 | 5 | MEDIUM | CA | Pinnacle Plus MYGA 5 Year Medium Band CA |
| DEL86680A285 | 7 | MEDIUM | CA | Pinnacle Plus MYGA 7 Year Medium Band CA |
| DEL86680A285 | 10 | MEDIUM | CA | Pinnacle Plus MYGA 10 Year Medium Band CA |
| DEL86680A285 | 3 | HIGH | CA | Pinnacle Plus MYGA 3 Year High Band CA |
| DEL86680A285 | 5 | HIGH | CA | Pinnacle Plus MYGA 5 Year High Band CA |
| DEL86680A285 | 7 | HIGH | CA | Pinnacle Plus MYGA 7 Year High Band CA |
| DEL86680A285 | 10 | HIGH | CA | Pinnacle Plus MYGA 10 Year High Band CA |

An initial vector is built 502 with all of these policy instances.

The initial vector is then transformed 504 by the builder 208 by eliminating from the vector any of those policy instances which could not be applicable because of Band, State, and/or Duration exhibited in the policy instance. These eliminations are performed by the builder 208 as follows:
1. Policy Band—The builder 208, based on the Premium Paid or, if the annuity product of the policy instance has been previously automatically renewed, the Cash Value at the Inception of the renewal date, determines 506 an applicable Band for each policy instance. Each annuity product can be issued under only one Band.
2. State—The builder 208, based on the state of issue for the policy instance, compares 508 the state of issue for the policy instance to the state of issue for the annuity product of the request. There can be only one state of issue for the relevant annuity product. Some annuity products have several state variances which impact the crediting rate.
3. Duration—The builder 208, based on the policy instances, determines 510 whether the annuity product of each policy instance is a fixed term product or otherwise. If a fixed term annuity product, then the product can be determined as either in the initial guarantee period or beyond that period (i.e., a zombie, with a growth rate based on a guaranteed minimum interest rate (GMIR)). The builder 208 performs the following logic operations:
   a. If the Cash Value given in the raw data (CV_{raw data}) equals the Surrender Value given in the raw data (SV_{raw data}), that is CV_{raw data}=SV_{raw data}, then the annuity product is determined 512 to be fixed term and in zombie limbo. Otherwise the annuity product is in the initial guarantee period.
   b. An annuity product in the initial guarantee period cannot have a duration less than the current product inforce duration. For example, a policy where CV_{raw data}<>SV_{raw data} that has been inforce for 6 years cannot have a duration of 3, 4 or 5 years, as it would have been a zombie. So, any policy instance for a product exhibiting a duration of 3, 4 or 5 years is removed 514 from the vector.
   c. An annuity product in zombie limbo cannot have a duration greater than the current policy inforce duration. So, a zombie product inforce 6 years cannot have a duration of 7 or 10 years, and any policy instances corresponding to duration of 7 or 10 years are removed 514 from the vector.
   d. If the annuity product of the policy instance provides a return of premium (ROP), and if the SV_{raw data} is less than the Premium Paid given in the raw data (PP_{raw data}) or value at most recent renewal given in the raw data (RR_{raw data}), as applicable, that is SV_{raw data}<PP_{raw data} or SV_{raw data}<RR_{raw data}, respectively, the annuity product of the policy instance does not have exhibit an ROP and the policy instance is removed 516 from the vector.
      Taking the Delaware Life example, for an annuity product with a policy instance exhibiting a $125,000/Medium Band premium, sold in Texas, only the following four policy instances are retained in the vector:

| QuadRe Product | Product | Product | Product | |
|---|---|---|---|---|
| ID | Duration | Band | State Rate | Product Instance Description |
| DEL86680A285 | 3 | LOW | DEF | Pinnacle Plus MYGA 3 Year Low Band |
| DEL86680A285 | 5 | LOW | DEF | Pinnacle Plus MYGA 5 Year Low Band |
| DEL86680A285 | 7 | LOW | DEF | Pinnacle Plus MYGA 7 Year Low Band |
| DEL86680A285 | 10 | LOW | DEF | Pinnacle Plus MYGA 10 Year Low Band |
| DEL86680A285 | 3 | MEDIUM | DEF | Pinnacle Plus MYGA 3 Year Medium Band |
| DEL86680A285 | 5 | MEDIUM | DEF | Pinnacle Plus MYGA 5 Year Medium Band |
| DEL86680A285 | 7 | MEDIUM | DEF | Pinnacle Plus MYGA 7 Year Medium Band |
| DEL86680A285 | 10 | MEDIUM | DEF | Pinnacle Plus MYGA 10 Year Medium Band |
| DEL86680A285 | 3 | HIGH | DEF | Pinnacle Plus MYGA 3 Year High Band |
| DEL86680A285 | 5 | HIGH | DEF | Pinnacle Plus MYGA 5 Year High Band |
| DEL86680A285 | 7 | HIGH | DEF | Pinnacle Plus MYGA 7 Year High Band |
| DEL86680A285 | 10 | HIGH | DEF | Pinnacle Plus MYGA 10 Year High Band |
| DEL86680A285 | 3 | LOW | CA | Pinnacle Plus MYGA 3 Year Low Band CA |
| DEL86680A285 | 5 | LOW | CA | Pinnacle Plus MYGA 5 Year Low Band CA |
| DEL86680A285 | 7 | LOW | CA | Pinnacle Plus MYGA 7 Year Low Band CA |
| DEL86680A285 | 10 | LOW | CA | Pinnacle Plus MYGA 10 Year Low Band CA |
| DEL86680A285 | 3 | MEDIUM | CA | Pinnacle Plus MYGA 3 Year Medium Band CA |
| DEL86680A285 | 51 | MEDIUM | CA | Pinnacle Plus MYGA 5 Year Medium Band CA |
| DEL86680A285 | 7 | MEDIUM | CA | Pinnacle Plus MYGA 7 Year Medium Band CA |
| DEL86680A285 | 10 | MEDIUM | CA | Pinnacle Plus MYGA 10 Year Medium Band CA |
| DEL86680A285 | 3 | HIGH | CA | Pinnacle Plus MYGA 3 Year High Band CA |
| DEL86680A285 | 5 | HIGH | CA | Pinnacle Plus MYGA 5 Year High Band CA |
| DEL86680A285 | 7 | HIGH | CA | Pinnacle Plus MYGA 7 Year High Band CA |
| DEL86680A285 | 10 | HIGH | CA | Pinnacle Plus MYGA 10 Year High Band CA |

### Policy Instance Projections for the Vector

The remaining vector, after elimination of inapplicable policy instances, can exhibit annuity attributes for a number of annuity products. For example, the vector can include annuity attributes for each remaining annuity property corresponding to the vector that reflect a valuation, respectively. That valuation in the raw data (CV_{raw data} and SV_{raw data}) is based on a particular date certain—either the “as of” date for the annuity product or, if more than one product, the batch of products. That “as of” date exhibited in the raw data may not be a current date of other date of the request. Therefore, for all policy instances remaining in the vector from the builder 208, the calculator 212 computes projections of a cash value (CV_{calc}) and surrender value (SV_{calc}) at the run date/valuation date of the policy (to match or compare with the CV_{raw data} and SV_{raw data}) and a cash value projection (CVₚᵣₒⱼ) and, as applicable, a surrender value projection (SVₚᵣₒⱼ), each at the end of current term duration period of the relevant annuity product corresponding to the request.

The CV_{calc} and SV_{calc} are compared with the policy instances of the vector to determine which policy instance(s) of the vector applies to a particular identified annuity product of the request.

The system 100 projects product values for CVₚᵣₒⱼ and surrender value (SVₚᵣₒⱼ) for all policy instances of the vector. Projections by the system 100 are calculated by the calculator 212 as follows:

The calculations depend on the annuity product type and whether the product would be automatically renewed, each as exhibited in the relevant policy instance of the vector. For each policy instance of the vector, the applicable CVₚᵣₒⱼ and SVₚᵣₒⱼ (unless the product is in zombie limbo) will be calculated.

Once a policy instance match has been made based on CV_{calc} and SV_{calc}, a cash value for a product of the matched policy instance is calculated for as of the end of the current guarantee period (CVₚᵣₒⱼ) as well as the projected surrender charge (SVₚᵣₒⱼ) for an automatic renewal.

### 1. Fixed Term Product Projections

Annuity products exhibited in policy instance for fixed term are distinguished by the system 100 as being either in the initial guarantee period (that is, the product is not yet in zombie limbo) or in duration exceeding the guarantee period (that is, the product is in zombie limbo and paying the MGIR).
a. If Zombie Cash Value @ Valuation Date<Guarantee Period
   The projection calculates CVₚᵣₒⱼ for the policy instance. The CVₚᵣₒⱼ for an annuity product that is in the guarantee period is based on the value at the prior anniversary of the product. The calculation makes the determination of the policy instance value at the prior anniversary and then adds the value between that anniversary and the date of CV_{raw data}, based on the equivalent daily interest crediting rate, to obtain the CVₚᵣₒⱼ. This matches calculations employed by annuity policy administration platforms.
b. If Zombie Surrender Value @ Valuation Date<Guarantee Period
   The projection calculates SVₚᵣₒⱼ as CV_{calc} minus the surrender charge for that policy instance as exhibited in the SV_{raw data}.
c. If Zombie Cash Value @ Guarantee Period End Date
   This projection calculates CVₚᵣₒⱼ only if there is a match for the product in the policy instance of the vector. The calculation includes CV_{raw data} multiplied by the guarantee period crediting rate.
d. If Zombie Cash Value @ Valuation Date>Guarantee Period
   The projection calculates CVₚᵣₒⱼ only if the policy instance exhibits that the annuity product is in zombie limbo, that is where CV_{raw data}=SV_{raw data} and the policy instance duration is less than the duration exhibited by the raw data (e.g., a policy instance exhibiting duration of 3 years for a product that is valued in the raw data 6 years from issue date in the raw data). In these instances, the CVₚᵣₒⱼ projection is calculated as CV_{raw data} plus CV_{raw data} multiplied times the Guaranteed Rate exhibited in the raw data (e.g., 3.5%) times the period from issue (e.g., 3 years), plus by additional period (e.g., another 3 years) at the MGIR rate for the product (e.g., 1%) using the CV_{calc} at the end of the 3-year guarantee period as the premium for the 3-year zombie period where the product is paying MGIR.

### 2. Automatically Renewing Product Projections

Referring to FIG. 7, in conjunction with FIGS. 5 and 6,
a. If Auto Renew Cash Value @ Valuation Date<Guarantee Period
   The projection CVₚᵣₒⱼ is calculated 702 the same as described in 1.a. through 1.d. above.
b. If Auto Renew Surrender Value @ Valuation Date<Guarantee Period
   This projection is the same calculation 704 as with a policy instance exhibiting a zombie in limbo.
c. If Auto Renew Cash Value @ Valuation Date>Guarantee Period
   The projection CVₚᵣₒⱼ for policy instances exhibiting 706 that the product has undergone an automatic renewal depends on occurrences exhibited in the policy instance, including:
The issue date is reset 708 to the day the policy auto-renewed.
The premium paid on the auto-renewal date is set 710 as the cash value of that policy instance at the end of the previous guarantee period.
The crediting rate is reset 712 to a formulaic rate for that carrier/product looked up on a rule table.
The surrender charge is reset 714 to apply the surrender charge rate for that product at year one.
A policy instance may have to undergo several cycles of renewal. For example, a policy that has been inforce for seven years with a three-year policy duration will have to undergo a renewal at the end of year three and six of the policy.
   The overall process for the cash value projection CVₚᵣₒⱼ for an automatically renewed product is:
1. Determine the Cash Value at the Inception of the most recent term duration period. For example, a 3-year duration MYGA that has been inforce for seven years will be in year one of a third term duration. This should be viewed as a policy that was issued one day after the sixth policy anniversary with a Premium equal to the cash value of the policy at the end of the second term of the policy.
2. A projection is made for each Policy Instance for each policy guarantee period. This process projects the accumulation at the end of a target date and/or guarantee period provided in the input. To do this for the above example—a 3-year MYGA in year 7—three calculations are required.
   i. Calculation One projects the value of the Policy Instance at the end of the first 3-year guarantee period.
   ii. Using this value, a lookup is performed for the Product Instance rate at the beginning of the second 3-year guarantee period from GET Policy Instance Guarantee Rate @ Date.
   iii. Lookup from the CUSIP to Product Master.RULE.Renewal Crediting Rate Basis whether the policy will renew at the new money rate (Delaware Life does this), the Guaranteed Renewal Rate (Principal Life, which was sold to Talcott Resolution, does this) or some other derivative (Prosperity pays new money rate+0.1%, but it also renews all policies regardless of duration for 5 years). If the policy does not renew and pays the new money rate, the next policy period is projected using the rate/duration/calculation specific to that carrier from Product Formula.RULE.Renewal Crediting Rate Formula. For example, to project a Prosperity policy, the premium would be the cash value at the end of the period, the Prosperity rate would be the new money rate+0.1%, and the projection would be Premium*(1+Prosperity Rate)\hat{ }Prosperity Duration (5 years).
   iv. Apply the carrier/policy calculation to estimate the rate based on the new money rate on the renewal date.
   v. Calculate the cash value. Date for the call, the policy renewal date, will be Issue Date+Policy Term.
   vi. The process is repeated for the third instance of the 7-year inforce policy for a three-year policy instance duration. Based on the new issue date and the policy/product duration, the process determines if the policy valuation date is less than the new policy duration end date.
      1) If the policy valuation date is less than the new policy period end date the process completed. The value from the most recent call for projected CVₚᵣₒⱼ at the end of the policy period—along with the new money crediting rate and statutory minimum—is saved.
      2) If the policy valuation date is greater than the new policy period end date, the process returns to steps c) and d) above and a re-projection is made for the policy using the new cash value at the end of the policy period and the appropriate rate for the projection. This is continued until the policy valuation date is less than the new policy period end date.
d. AR Surrender Value @ Valuation Date>Guarantee Period
   This is the same calculation 716 as with a zombie policy.
e. AR Cash Value @ Guarantee Period End Date>Valuation Date
   This projection is only performed for a policy instance which has been determined through the matching algorithm to be the policy instance associated to the DTCC policy/contract. Once the instance has been established and the cash value at the prior policy renewal date is established, the crediting rate for the policy duration for the renewed policy is looked up 720 and used to project the cash value of the renewed policy to the next policy duration end date.
f. AR Surrender Value @ Guarantee Period End/Conversion Date+1
   This value is the surrender value of a policy the day after it auto-renews 722 (taking into account a 30-day conversion window). It will use the projected cash value at the end of the current guarantee period and multiply 724 this by the surrender charge percentage associated with year one of the renewed policy.

### Policy Duration State Determination

Referring to FIG. 6, in conjunction with FIGS. 1-5 and 7, at a high level, the process will receive data policy by policy from the DTCC API or platform (determination will be made whether there is an individual policy call from the DTCC API, whether a block of data is to be loaded either by carrier or overall by distributor, or otherwise, into a working vector/array for the process.

Rules tables will be populated, either on the fly or in bulk or stream, by carrier and CUSIP for a) the method for estimating/deriving the inforce policy details, including the next renewal date, for the policy and b) if applicable, the method for the CUSIP. Some carriers have CUSIPs which reflect product duration and others don't, so this is a policy level consideration for some carriers.

The CUSIP processing approach is determined by GET Product Details from CUSIP. The parsing for Product Details rules tables determines:
If the product is an automatic renewal product and the duration is known (not varies), the AR CUSIP Duration process will apply.
If the product is a zombie and the duration is known, the Zombie CUSIP Duration process will apply.
If the product is an automatic renewal product and the duration is not known (varies), the AR without CUSIP Duration process will apply.
If the product is a zombie and the duration is not known, the Zombie without CUSIP Duration process will apply.
If the product is Fixed Chassis, the Fixed Chassis with Option will apply.
   All the algorithms detailed below are executed for each instance of a product in the product array. If the duration is known as per the CUSIP, a vector/array is built of all of the product instances at that duration in order to match the Product Instance (and product instance name) based on the cash value projection. With an indeterminate duration, all durations that could apply are calculated for all applicable policy instances.

### Summary of Calculations

### B. Variable Naming Convention

There are several types of variables in the formulas which are denoted throughout. The variable type will precede the variable name. These include:
DTCC—a value from the DTCC POV File Extract
RULE—a value which can be derived from a rules table access function.
CALC—a calculated value used in the process.
ARRAY—A variable either saved to or used as a value within an instance calculation
PROJ—is a projected value of a policy instance (as detailed in Policy Instance Projections). Projected values are underscored.
   The following calculates interim values required for policy instance projections.

### C. Interest Rate Calculations

$$CALC Policy Instance Issue Daily Crediting Rate = ( 1 + RULE \cdot Product Instance Rate \cdot Policy Instance Rate @ Issue Date \hat{} ( 1 / 365 ) - 1 ) . So a 5 \% annual crediting rate = \text{.0133681} \% daily crediting rate .$$

$$CALC Policy Instance Renewal Daily Crediting Rate = ( 1 + RULE \cdot Product Instance Date \cdot Policy Instance Rate @ Renewal Date \hat{} ( 1 / 365 ) - 1 ) .$$

### D. Date Calculations

CALC Policy Term=(DTCC Valuation Date−DTCC Policy Issue Date (in terms of days)/365)/ARRAY MYGA Term. The number of terms for an automatically renewing policy is determined by the inforce duration of the policy as of the DTCC run date divided by the MYGA Term associated with the policy instance array. The resulting figure is an integer always rounded up so that a calculated term of 2.01 means the policy term is 3 periods.
CALC Policy Years Inforce=Years Difference Valuation Date−Issue Date. The resulting value is a number which is then converted to an integer—always rounding up.
CALC Policy Years Inforce Since Renewal=Years Difference DTCC Valuation Date−Policy Instance Renewal Date @ CALC Policy Term. The resulting value is converted to an integer—always rounding up.

$$CALC Number of Days Into Current Term = Days Difference DTCC Valuation Date - CALC Prior Anniversary Date$$

$$CALC Number of Days Since Issue = Days Difference DTCC Valuation Date - DTCC Issue Date$$

$$CALC Zombie Policy Term End Date = Issue Date + Policy Duration ( from product , DTCC Surrender Charge End Date , or Duration Range matching algorithm ) .$$

$$CALC Months in Zombie Mode = \# Months between DTCC Policy Valuation and Zombie Policy Term End Date$$

CALC Next Term End Date is a multi-part calculation.

$$IF CALC Durations Inforce = 0 , CALC Next Term End Date = DTCC Policy Issue + ARRAY \cdot Policy Duration ELSE$$

### 1. Policy Premium Adjustments

Some policies provide a cash bonus upon issue which will apply to the premium if the policy remains inforce for the duration of the guarantee period.

$$CALC Adjusted Policy Premium = DTCC Premium @ Policy Issue + ( DTCC Premium * 1 + RULE \cdot Product ID Rules \cdot Premium Bonus \% )$$

### E. Surrender Charge Calculations

Basic Surrender Calculations based on DTCC provided values:

$$CALC \cdot Surrender Amount = DTCC Cash Value - DTCC Surrender Value$$

$$CALC Surrender \% of Current Cash Value = CALC \cdot Surrender Amount / DTCC Cash Value$$

This provides the surrender value of the policy at the projected date (usually the DTCC Run Date). It considers the following variances on surrender charge:
Is a penalty-free withdrawal allowed in year one of the policy?
Is a penalty-free withdrawal allowed in years 2+ of the policy?
Is there a cumulative penalty-free withdrawal for the policy?
Is the penalty-free withdrawal option accumulated interest on the policy only?
Does an MVA adjustment apply to the surrender charge?
What is the estimated value of the MVA on the projected date?
Is there a return of premium provision for the policy?

### 1. Product Rules for Surrender Calculations

Product rules are obtained from rules tables. Some product rules apply at the product level and are used in the surrender calculations.
RULE.Product ID Rules.Withdrawal Value Basis (Current Value, Previous Anniversary Cash Value).
RULE.CUSIP to Product Master.Renewal Crediting Rate Basis (New Money Rate, Guaranteed Minimum Rate, Carrier Algorithm, Product Algorithm)
   The product rules below are selected for the Product Instance being projected within the Policy Instance Array. The values will vary with each product instance in the array.
RULE.Product Instance.MVA Flag
RULE.Product Instance.Annual Free Withdrawal %
RULE.Product Instance.Year One WD Flag
RULE.Product Instance.ROP Flag
RULE.Product Instance.No Withdrawal Flag
RULE.Product Instance.Interest Only Withdrawal Flag
   A policy can have one or more liquidity provisions depending on product design.
   For example, some products allow 10% withdrawal of cash value without penalty, some allow the withdrawal of interest accumulated with penalty, and some offer both (the higher value of the two, which reduces the withdrawal penalty the most). The ROP can also work with one of these provisions, as in the later years of a policy the 10% withdrawal provision may provide a better outcome than the ROP where all credited interest is lost. The MVA has an impact on all of these calculation as well.

The following sections provide a summary of the logic for each variation encountered when calculating the surrender charge penalty to match the DTCC Surrender Value provided by the carrier.
a. No Withdrawal Available
   If the policy instance does not allow a withdrawal this will be set here:

### IF RULE.Product Instance.No Withdrawal Flag=“Y”

CALC Withdrawal Available @ Valuation Date=0

### ALL REMAINING WITHDRAWAL CALCULATIONS IN THIS SECTION ARE SKIPPED FOR THIS POLICY INSTANCE.

b. Penalty Free Withdrawal Allowed
   Penalty free withdrawal on a policy can come from either a fixed percentage of cash value of the policy or the interest accumulated on the policy or a combination of both. This calculation is done first before determining surrender charges and MVA adjustments. To calculate the Free Withdrawal Amount.
1. Begins with the applicable cash value for the calculation—either the current cash value or the cash value as of the previous anniversary date.
2. If the policy is in year one—either from issue or from auto-renewal—checks to see if withdrawals on that product are allowed in year one. If withdrawals are not allowed then sets the Surrender Charge Basis to the current cash value and moves to the second step, surrender charge calculation.
3. If the policy is in year 2+:
   a. If a % withdrawal is allowed, amount is multiplied by the applicable cash value.
   b. If an interest withdrawal is allowed, the interest accumulated on the policy is calculated by subtracting the premium paid on the policy (or applied at the automatic renewal of the policy) from the applicable cash value.
   c. The Free withdrawal amount then is either 0 (if first year and not allowed), or the higher of the % withdrawal amount or interest accumulated. Policies inforce for 4+ years tend to have a higher amount of interest available for withdrawal than 10% of the cash value if this is an option.
4. the free withdrawal amount is subtracted from the applicable cash value to determine the Surrender Charge basis for the policy.

### Surrender Charge Calculation

c. Penalty for Withdrawal
   The surrender charge is applied to the Surrender Charge Basis for the policy.
   Each policy has a surrender charge schedule with a % penalty applied depending on the number of years the policy has been inforce from either issue or automatic-renewal. Below is a sample of surrender charge tables for products of varying guarantee period durations:

Surrender Schedule (s)

| Description | 1 | 2 | 3 | 4 | 5 | 6 | 7 | 8 | 9 | 10 |
|---|---|---|---|---|---|---|---|---|---|---|
| 5 Year | 9.0 | 8.0 | 7.0 | 6.0 | 5.0 | — | — | — | — | — |
| 6 Year | 9.0 | 8.0 | 7.0 | 6.0 | 5.0 | 4.0 | 0.0 | — | — | — |
| 7 Year | 9.0 | 8.0 | 7.0 | 6.0 | 5.0 | 4.0 | 3.0 | 0.0 | — | — |

The Surrender Charge is calculated by multiplying the Surrender Charge Basis by the rate which applies to the number of years the policy has been inforce since issue or automatic-renewal.

### 2. Market Value Adjustment Calculations

Market Value Adjustment is a carrier and sometimes product-specific algorithm applied to some policies (issued with the provision in place).
The variables associated with an MVA calculation include and are mostly limited to:
The policy cash value.
The yield at the time of issue—either “new money” product yield or T-bill yield for the equivalent duration product.
The yield at the time of the surrender charge calculation—either product yield or T-bill yield for the equivalent duration product—something published and hence legally defensible.
The time remaining on the guarantee period of the policy.
   The same variables are generally employed, but calculations differ by carrier/product. The variables used for MVA calculation includes:
DTCC Initial Premium
DTCC Issue Date and/or Last Date of Automatic Renewal
Projected Policy Value @ Valuation Date
Projected Policy Surrender Value @ Valuation Date (before MVA applied).
DTCC Valuation Date
Product Instance Rate @ Issue
Product Instance Rate @ Valuation Date
T-Bill Rate for applicable product duration @ Issue (3, 5, 7 year or closest)
T-Bill Rate for applicable product duration @ Valuation Date
   All variables are gathered for each policy instance in the valuation/value matching algorithm process and the applicable product MVA formula is then applied.
   The system and method embodiments employ a database of MVA calculations according to carrier formulas, for all carriers/products. The MVA calculation is performed in the determination of the surrender value of the policy. Some examples of MVA calculations include:

$$Lincoln National : CALC \cdot MVA Rate = ( 1 + Guarantee Rate at Issue ) / ( 1 + Guarantee Rate at Valuation Date ) - 1$$

$$Standard Life : CALC \cdot MVA Rate = ( 1 + ( Guarantee Rate at Issue - Current Rate at Issue - 5 \% ) \hat{} Years remaining in policy term$$

$$Delaware Life : CALC \cdot MVA Rate = ( T - Bill Rate at Issue - T - bill rate at Valuation Date ) \hat{} ( Number of months from valuation date to guarantee period term end date ) / 12$$

In a volatile interest rate environment, the MVA calculation significantly attenuates the surrender value difference among products, especially when the duration of products is applied in the calculation.
The CALC.MVA Factor is calculated as a % which can be either positive or negative. This percentage is applied to the cash value of a policy subject to withdrawal penalties/adjustments in the calculation of the surrender value.
a. Applying the MVA to determine the Unadjusted Surrender Value
   As noted, the MVA Factor is a percentage which is either negative or positive. A negative MVA happens when market interest rates have gone up since issue and a positive MVA happens when market interest rates have gone down since issue.

$$The Gross MVA = Surrender Charge {Basis}^{*} MVA Factor .$$

The unadjusted surrender value is calculated from surrender charge and rate:
Unadjusted Surrender Value=Applicable Current Cash Value−Surrender Charge+/−Gross MVA. The unadjusted surrender value applies unless there is an exception to the amount.

### Applying Return of Premium to the Policy

If the Unadjusted Surrender Value is less than the Premium Paid for the policy AND the policy instance has a “Return of Premium” rider or provision, the Surrender Value is adjusted upward to equal the Premium paid on the policy.
If the unadjusted Surrender Value is greater than the Premium Paid for the policy, the Surrender Value is equal (without any adjustment) to the Unadjusted Surrender Value.
b. Checking for and Applying a Statutory Minimum Value
   Most state insurance regulatory bodies require the penalty-losses on a MYGA to be capped at a certain percentage of the cash value of the policy. The “standard” maximum loss amount is 12.5% of the policy value—so for example a policy with a cash value of $100,000 can never have a surrender value lower than $87,500 regardless of the combined penalty and MVA on the policy.
   After calculating the unadjusted surrender value a final check is made whether the penalty applied brings the value to lower than 87.5% of the current cash value. If it does, the surrender value of the policy is adjusted to the 87.5% floor of the cash value.
c. Applied MVA
   The Applied MVA is the actual MVA applied to the policy at valuation. It can be positive or negative. If it is negative it cannot cause the surrender value to drop below either the premium paid (if ROP policy) or the statutory minimum for that product. The Applied MVA is employed to apply to the policy instance matching process.
   The Applied MVA used for matching is:
1. If the Gross MVA is positive, then Applied MVA=Gross MVA.
2. If the Gross MVA is negative and the policy has a return of premium provision:
   a. IF the Unadjusted Surrender Value>Premium Paid

| | |
|---|---|
| i. | IF Premium Paid − Unadjusted Surrender Value < Surrender |
| | Charge then Applied MVA = 0 |
| ii. | ELSE Applied MVA = Applicable Cash Value − Surrender |
| | Charge. |

| | |
|---|---|
| b. | ELSE MVA = 0. |

| | |
|---|---|
| 3. | If the Gross MVA is negative with no ROP provision. |

| | |
|---|---|
| a. | IF Unadjusted Surrender Value > Minimum Surrender Value (87.5% |
| | of Cash Value) based on statutory floor, Applied MVA = Gross |
| | MVA. |
| b. | ELSE Applied MVA = Minimum Surrender Value + Surrender |
| | Charge (i.e. the difference between the surrender charge and most |
| | the MVA could be with the statutory minimum). |

d. Calculation Surrender Charge Rate
   The calculation for the surrender charge for a policy varies by whether the policy has a MVA. For a policy instance with no MVA, the following applies:

$$( DTCC Cash Value - CALC Withdrawal Available ) = CALC Policy Value Subject to Penalty$$

$$CALC Policy Value Subject to Penalty - DTCC Surrender Value = CALC Withdrawal Penalty$$

$$CALC Withdrawal Penalty / CALC Policy Value Subject to Penalty = CALC Calculated Surrender Charge Rate$$

For a policy with a market value adjustment, the MVA is incorporated into the DTCC surrender value reported by the carrier. However, to match the surrender charge table, the impact of the MVA is removed from the value reported by the carrier. This is performed as follows:

$$( DTCC Cash Value - Free Withdrawal ) = CALC Policy Value Subject to Penalty$$

Calculate MVA Rate for the policy instance applying the MVA formula at the policy instance duration to the Policy Value Subject to Penalty.

$$CALC Policy MVA = Policy Value Subject to {Penalty}^{*} ( 1 + CALC MVA Rate )$$

$$CALC Policy Value Adjusted for MVA + DTCC Surrender Value = CALC Withdrawal Penalty$$

$$CALC Withdrawal Penalty / CALC Policy Value Subject to Penalty = CALC Calculated Surrender Charge Rate$$

### 3. Cash Value Calculations

Several determinations yield the cash value outside of projection. The assumptions behind these determinations are:

$$CALC Prior Anniversary Cash Value = CALC Adjusted Policy {Premium}^{*} ( 1 + RULE \cdot Product Instance Rate \cdot Policy Instance Rate @ Issue Date / Renewal Date ) \hat{} ( Current Years Duration of Policy - 1 ) .$$

### Policy Matching by the Matcher

The policy matching process is executed policy by policy following the completion of projections from the applicable policy instance vector/array. The policy instance for each policy is employed. The fields below from the Zombie policy vector/array are employed for both the auto-renewing and zombie policy matching:

Applicable Policy Instance Array -- Zombie
Policy ID -- QuadRe Product ID - Policy Number

Issue Date
Premium Paid
Valuation Date
Policy Status
Policy GMIR @ Issue Date
Product Duration (x)
Product Instance ID (y)
Product Instance Description
Policy Instance Issue Rate
Projected Cash Value @ Valuation Date
Projected Surrender Value @ Valuation Date
Projected Surrender Charge @ Valuation Date
Projected MVA @ Valuation Date

Also available for the matching algorithm are the DTCC Cash Value and DTCC Surrender Value.
There are two matching procedures that can be performed: (1) matching a duration dependent sensitivity value and (2) matching a range-based validation. A visual example of the inputs to these matching procedures is shown below on a MYGA with 3 product variances/yields for 3- and 5-year duration products.
The policy valuation calculation for most carriers occurs in a variety of different, typically mainframe-based, policy administration systems. In the case of policies which have a compound interest policy valuation projection (i.e. they have not auto-renewed with a new crediting rate), the value of the policy matches (or closely thereto) the value of a projection for the product with the rules matching determination below, with minor variances associated with the calculation approach for the carrier (some credit daily, some monthly, some credit prior years on an annual basis and then the time after that between anniversaries on a daily basis). To mitigate this noise, the policy value provided by the carrier through DTCC should fall within a sensitivity range to be considered a match.
There are two primary policy matching procedures employed. These include Range Matching for Duration and Adjusted Sensitivity Value Matching for Policy Instance.

### F. Policy Instance Matching Determinations

The policy matching procedures have two objectives. The first objective, when necessary, is determination of duration of the policy. This duration drives the renewal date of the policy and provides the action date required by the bank/distributor.
If the CUSIP indicates the duration of the policy, duration matching is not a requirement. If the duration is unknown based on CUSIP, duration matching is immensely valuable.
The second objective, when possible, determines the policy instance of a policy.
For example, a bank may know that a policy is a three-year policy from the CUSIP (most won't), but if it can be determined that the policy also has a 10% withdrawal provision and a market value adjustment this is more valuable information.

### 1. Policy Vector/Array Status

The policy matching cycles through the Applicable Policy Instance Vector/Array to set a policy status for instances. Four outcomes are possible for policy instances within the ARRAY. The statuses apply both to the duration (from the Policy Range Matching algorithm) and the Policy Instance evaluation (from the Adjusted Sensitivity Value Matching algorithm).
STRONG MATCH—DTCC reported values fall uniquely within one range and within both other ranges. Policy duration is set.
PROBABLE MATCH—DTCC Reported Values all fall within the range of the same duration (but there are no unique range matches) or one unique match coupled with one but not two range matches. Policy Duration is set. This is most likely to happen on policies with a relatively low duration.
POSSIBLE MATCH—Two DTCC Reported values fall within the range of the same duration.
NO MATCH.
   Once policy array matching has been executed, a status is set for the Applicable Policy Instance Array with the same status.
   If policy duration is not known, the Range Matching for Duration processes a status for each policy instance, as follows:
1. IF there is one instance of STRONG MATCH, the ARRAY.Duration policy array status is set to STRONG MATCH and this value is used for output for this policy.
2. IF there is one instance of PROBABLE MATCH, the ARRAY.Duration policy array status is set to PROBABLE MATCH and this value is used for output for this policy.
3. IF there is one or more instances of POSSIBLE MATCH, the ARRAY.Duration policy array status is set to POSSIBLE MATCH. This is flagged for further analysis, but it is not assumed that a match has been found for either duration or policy instance.
4. If all instances are equal to NO MATCH, the ARRAY.Duration policy array status is set to NO MATCH. Exception analysis follows in this situation.
   For all policy instance array, the process attempts to match the policy instance as follows:
1. IF there is one instance of STRONG MATCH, the ARRAY.Policy Instance policy array status is set to STRONG MATCH and this value is used for output for this policy.
2. IF there is one instance of PROBABLE MATCH, the ARRAY.Policy Instance policy array status is set to PROBABLE MATCH and this value is used for output for this policy.
3. IF there is one or more instances of POSSIBLE MATCH, the ARRAY.Policy Instance policy array status is set to POSSIBLE MATCH. This is then flagged for further analysis, and it is assumed that a match has been found for either duration or policy instance.
4. If all instances are equal to NO MATCH, the ARRAY.Policy Instance policy array status is set to NO MATCH. Exception analysis then follows in this situation.

### 2. Policy Range Evaluation

In the instance that a policy duration is not known by the CUSIP, a range validation occurs. Policy Range validation is ONLY done for product instances where the duration of the product can't be determined by the CUSIP and/or zombie status of the policy. Policy Range validation is ONLY used to set the duration of the product—the product instance within that range is be determined by Projected Value Sensitivity Analysis.
For a simplified example, assume an Applicable Policy Instance Array with the following values:

Security Benefit Life Advanced Choice Annuity -- $100,000 Premium,
Issue Date Jan. 1, 2019, Valuation Date Apr. 1, 2024

| | | | | | Projected |
|---|---|---|---|---|---|
| | | | Projected | Projected | Surrender |
| Policy Instance Description Value | Yield @ | Projected | Surrender | Surrender | Charge (minus |
| Surrender Value Surrender Cost MVA) | Issue | Cash Value | Value | Cost | MVA) |
| 3-Year High Band Interest Only MVA | 2.900% | $121,520.89 | $109,545.62 | $11,975.27 | 8.8690% |
| 3-Year High Band 10% WD MVA | 2.850% | $121,148.24 | $110,227.46 | $10,920.78 | 8.1130% |
| 3-Year High Band Interest Only No MVA | 2.700% | $119,978.53 | $109,325.69 | $10,652.84 | 8.8790% |
| 3-Year High Band 10% WD No MVA | 2.650% | $120,191.07 | $110,440.70 | $9,750.37 | 8.1124% |
| 5-Year High Band Interest Only MVA | 3.100% | $121,800.54 | $110,733.87 | $11,066.67 | 7.6513% |
| 5-Year High Band 10% WD MVA | 3.050% | $121,427.16 | $111,045.14 | $10,382.02 | 7.2000% |
| 5-Year High Band Interest Only No MVA | 3.000% | $121,054.75 | $111,780.56 | $9,274.19 | 7.6612% |
| 5-Year High Band 10% WD No MVA | 2.950% | $120,683.31 | $111,994.11 | $8,689.20 | 7.2000% |
| 7-Year High Band Interest Only MVA | 3.600% | $125,104.62 | $120,718.92 | $4,385.69 | 3.3387% |
| 7-Year High Band 10% WD MVA | 3.550% | $124,722.73 | $120,009.81 | $4,712.92 | 3.5988% |
| 7-Year High Band Interest Only No MVA | 3.400% | $123,582.95 | $119,628.54 | $3,954.41 | 3.1998% |
| 7-Year High Band 10% WD No MVA | 3.350% | $123,204.98 | $118,771.12 | $4,433.87 | 3.5988% |

Taking the calculated values from the Available Policy Instance Array and summarizing them into ranges yields the following:

Range-Based Assessment

| | CV Range | SV Range | SC Range |
|---|---|---|---|
| 3-Year | $121,520-$119,978 | $109,325-$110,440 | 8.11%-8.88% |
| Duration | | | |
| 5-Year | $121,800-$120,683 | $111,994-$110,733 | 7.2%-7.7% |
| Duration | | | |
| 7-Year | $125,104-$123,204 | $120,719-$118,771 | 3.2%-3.6% |
| Duration | | | |

The policy range matching works within the projected ranges of values at the various durations available for a policy.

### 3. Range Matching for Duration

For policies where the duration is unknown, the range matching determines the like duration of the policy. If the policy duration is known by the CUSIP and/or because the carrier provided the Surrender Charge Expiration Date in the feed, this step is skipped and the process proceeds directly to Adjusted Sensitivity Value Matching for Policy Instance.
This creates one of four outcomes.
1. STRONG MATCH—DTCC reported values fall uniquely within one range and within both other ranges. Policy duration is set.
2. PROBABLE MATCH—DTCC Reported Values all fall within the range of the same duration (but there are no unique range matches) or one unique match coupled with one but not two range matches. Policy Duration is set. This is most likely to happen on policies with a relatively low duration.
3. POSSIBLE MATCH—Two DTCC Reported values fall within the range of the same duration.
4. NO MATCH.
   Further processes or systems may be employed for situations where matching is limited or not possible.
   Range matching then proceeds as follows.
1. Is any DTCC Value uniquely within the range of projected values for cash value?
   a. If Yes, confirm that the other two values are within the range for that policy duration (or uniquely within that range).
      i. If both are within the range, set the policy duration to that range. Set the policy instance status to STRONG MATCH.
      ii. If only one is within the range, set the policy duration to that range. Set the policy instance status to Probable Match.
      iii. Otherwise, set the policy instance status to No Match.
2. ELSE, are all three within the range of projected values (not uniquely)?
   a. Is this the case with only one range duration?
      i. If yes, set the policy duration to that range. Set the policy instance status to probable match.
      ii. If no, set the policy instance to possible match.
3. If two policy values fall within the range of the applicable durations, set the policy instance status to Possible Match.
   Once a policy instance status within a vector/array has been set to either Strong or Probable Match, processing is stopped. Processing, however, continues for possible match as several policy instances may have this status and further determination is required.
   The matching is only required when the policy duration is unknown so the policy instance array will always have multiple durations and hence multiple ranges of durations (even if there is only one policy instance value per range). Here are a few examples:
   Take a Security Benefit Life Policy—$100,000, issued Jan. 1, 2019 valued on 4/1/0224 which reports:
DTCC Cash Value=$121,000
DTCC Surrender Value=$110,400
CALC Surrender Charge=8.4%
   Comparing this to the projected policy instances for this policy. First, a look at the projected cash value range:

Security Benefit Life Advanced Choice Annuity -- $100,000 Premium,
Issue Date Jan. 1, 2019, Valuation Date Apr. 1, 2024

| | | Projected | Projected | Projected | Projected |
|---|---|---|---|---|---|
| | Yield @ | Cash | Surrender | Surrender | Surrender Charge |
| Policy Instance Description | Issue | Value | Value | Cost | (minus MVA) |
| 3-Year High Band Interest Only MVA | 2.900% | $121,520.89 | $109,545.62 | $11,975.27 | 8.8690% |
| 3-Year High Band 10% WD MVA | 2.850% | $121,148.24 | $110,227.46 | $10,920.78 | 8.1130% |
| 3-Year High Band Interest Only No MVA | 2.700% | $119,978.53 | $109,325.69 | $10,652.84 | 8.8790% |
| 3-Year High Band 10% WD No MVA | 2.650% | $120,191.07 | $110,440.70 | $9,750.37 | 8.1124% |
| 5-Year High Band Interest Only MVA | 3.100% | $121,800.54 | $110,733.87 | $11,066.67 | 7.6513% |
| 5-Year High Band 10% WD MVA | 3.050% | $121,427.16 | $111,045.14 | $10,382.02 | 7.2000% |
| 5-Year High Band Interest Only No MVA | 3.000% | $121,054.75 | $111,780.56 | $9,274.19 | 7.6612% |
| 5-Year High Band 10% WD No MVA | 2.950% | $120,683.31 | $111,994.11 | $8,689.20 | 7.2000% |
| 7-Year High Band Interest Only MVA | 3.600% | $125,104.62 | $120,718.92 | $4,385.69 | 3.3387% |
| 7-Year High Band 10% WD MVA | 3.550% | $124,722.73 | $120,009.81 | $4,712.92 | 3.5988% |
| 7-Year High Band Interest Only No MVA | 3.400% | $123,582.95 | $119,628.54 | $3,954.41 | 3.1998% |
| 7-Year High Band 10% WD No MVA | 3.350% | $123,204.98 | $118,771.12 | $4,433.87 | 3.5988% |

The DTCC Cash Value indicates that the policy duration is either 3-year or 5-year but it cannot be determined uniquely from the cash value. So, the process proceeds to determine the surrender value:

Security Benefit Life Advanced Choice Annuity -- $100,000 Premium,
Issue Date Jan. 1, 2019, Valuation Date Apr. 1, 2024

| | | | Projected | Projected | Projected |
|---|---|---|---|---|---|
| | Yield @ | Projected | Surrender | Surrender | Surrender Charge |
| Policy Instance Description | Issue | Cash Value | Value | Cost | (minus MVA) |
| 3-Year High Band Interest Only MVA | 2.900% | $121,520.89 | $109,545.62 | $11,975.27 | 8.8690% |
| 3-Year High Band 10% WD MVA | 2.850% | $121,148.24 | $110,227.46 | $10,920.78 | 8.1130% |
| 3-Year High Band Interest Only No MVA | 2.700% | $119,978.53 | $109,325.69 | $10,652.84 | 8.8790% |
| 3-Year High Band 10% WD No MVA | 2.650% | $120,191.07 | $110,440.70 | $9,750.37 | 8.1124% |
| 5-Year High Band Interest Only MVA | 3.100% | $121,800.54 | $110,733.87 | $11,066.67 | 7.6513% |
| 5-Year High Band 10% WD MVA | 3.050% | $121,427.16 | $111,045.14 | $10,382.02 | 7.2000% |
| 5-Year High Band Interest Only No MVA | 3.000% | $121,054.75 | $111,780.56 | $9,274.19 | 7.6612% |
| 5-Year High Band 10% WD No MVA | 2.950% | $120,683.31 | $111,994.11 | $8,689.20 | 7.2000% |
| 7-Year High Band Interest Only MVA | 3.600% | $125,104.62 | $120,718.92 | $4,385.69 | 3.3387% |
| 7-Year High Band 10% WD MVA | 3.550% | $124,722.73 | $120,009.81 | $4,712.92 | 3.5988% |
| 7-Year High Band Interest Only No MVA | 3.400% | $123,582.95 | $119,628.54 | $3,954.41 | 3.1998% |
| 7-Year High Band 10% WD No MVA | 3.350% | $123,204.98 | $118,771.12 | $4,433.87 | 3.5988% |

The value of $110,400 can ONLY be found in the projected surrender value range of 3-year products. So, this means there is a UNIQUE match for duration at 3 years for this product. To confirm that this is accurate, the process also compares the CALC projected surrender charge for that policy instance of 8.4%.

Security Benefit Life Advanced Choice Annuity -- $100,000 Premium,
Issue Date Jan. 1, 2019, Valuation Date Apr. 1, 2024

| | | Projected | Projected | Projected | Projected |
|---|---|---|---|---|---|
| | Yield @ | Cash | Surrender | Surrender | Charge |
| Policy Instance Description Value | Issue | Value | Value | Cost | (minus MVA) |
| 3-Year High Band Interest Only MVA | 2.900% | $121,520.89 | $109,545.62 | $11,975.27 | 8.8690% |
| 3-Year High Band 10% WD MVA | 2.850% | $121,148.24 | $110,227.46 | $10,920.78 | 8.1130% |
| 3-Year High Band Interest Only No MVA | 2.700% | $119,978.53 | $109,325.69 | $10,652.84 | 8.8790% |
| 3-Year High Band 10% WD No MVA | 2.650% | $120,191.07 | $110,440.70 | $9,750.37 | 8.1124% |
| 5-Year High Band Interest Only MVA | 3.100% | $121,800.54 | $110,733.87 | $11,066.67 | 7.6513% |
| 5-Year High Band 10% WD MVA | 3.050% | $121,427.16 | $111,045.14 | $10,382.02 | 7.2000% |
| 5-Year High Band Interest Only No MVA | 3.000% | $121,054.75 | $111,780.56 | $9,274.19 | 7.6612% |
| 5-Year High Band 10% WD No MVA | 2.950% | $120,683.31 | $111,994.11 | $8,689.20 | 7.2000% |
| 7-Year High Band Interest Only MVA | 3.600% | $125,104.62 | $120,718.92 | $4,385.69 | 3.3387% |
| 7-Year High Band 10% WD MVA | 3.550% | $124,722.73 | $120,009.81 | $4,712.92 | 3.5988% |
| 7-Year High Band Interest Only No MVA | 3.400% | $123,582.95 | $119,628.54 | $3,954.41 | 3.1998% |
| 7-Year High Band 10% WD No MVA | 3.350% | $123,204.98 | $118,771.12 | $4,433.87 | 3.5988% |

The calculated surrender charge of 8.4% falls within the duration range of the 3-year policies, so this affirms the unique match found for surrender value.
For this policy, the ARRAY.Duration policy array status is set to STRONG MATCH.

### 4. Policy Instance Evaluation

For the Adjusted Sensitivity Value Matching, the ADJUSTED SENSITIVITY FACTOR is calculated for each policy instance of the vector array, for projected cash value, projected surrender value, and projected surrender charge. Projected cash value and surrender value are calculated as a percentage of initial premium paid. Projected surrender charge is calculated as a percentage of the cash value at the valuation date.

$$CALC Cash Value Sensitivity Factor = ABS ( Lowest Delta Among Cash Values in the Applicable Policy Instance Array ) / DTCC Premium Paid$$

$$CALC Surrender Value Sensitivity Factor = ABS ( Lowest Delta Among Surrender Values in the Applicable Policy Array ) / DTCC Premium Paid$$

$$CALC Surrender Charge Sensitivity Factor = ABS ( Lowest Delta Among Surrender Charges in \$ )$$

$$/ DTCC Cash Value$$

In the following example, a product with a known duration (all instances are three years) has been inforce 7 years, 9 months. It has two policy instance options—one with a 10% withdrawal provision and one with an interest-only withdrawal provision. The product has automatically renewed twice. The Applicable Policy Instance Array is the following:

| SBL814121166- | |
|---|---|
| P12345653453 | |
| DTCC Premium Paid | $50,000.00 |
| DTCC Issue Date | Apr. 1, 2016 |
| DTCCValuation Date | Jan. 1, 2024 |
| | Product Duration (x) = 3 |

3LOWDEFN0YNN
3-Year 10% WD MVA Low Band
1.30%
$58,576.32
$53,831.64
8.00%
$527.19
$51,975.46
2.90%
2.90%
$56,629.73
1.95%
1.95%

Product Duration (x) = 3

3LOWDEFN0NYN
3-Year Interest Only
WD MVA Low Band
1.35%
$58,799.09
$54,036.37
8.00%
$529.19
$52,052.46
2.95%
2.95%
$56,796.34
2.000%
2.000%

Based on this, the ADJUSTED SENSITIVITY FACTOR is determined to be 0.445% for the projected cash value, 0.409% for the surrender value, and 0.03% for the surrender charge.

Adjusted Sensitivity Factor Calculation

| | Smallest Delta | ASF |
|---|---|---|
| Cash Value | $222.77 | 0.44553% |
| Surrender Value | $204.72 | 0.40945% |
| Surrender Charge | $18.04 | 0.03000% |

### 5. Adjusted Sensitivity Value Matching for Policy Instance

Comparison of the DTCC values with the projected policy instance values within a duration is made to (attempt to) identify the policy instance, and thus the policy parameters upon launch, within a duration.
NOTE that the surrender charge is not be used as the policy duration has been set. All instances of the policy within a duration should have, depending on the available funds for withdrawal, close to the same surrender charge. The surrender value is employed only to confirm the cash value match.
Once the duration of a policy has been set—either through CUSIP or through the range matching, the Adjusted Sensitivity Value Matching is employed to (attempt to) determine the policy instance. The Adjusted Sensitivity Matching first checks the DTCC reported cash values versus policy instances projected values applying the Adjusted Sensitivity Factor. If a unique match is found, the value is confirmed with the surrender value.
NOTE that the Adjusted Sensitivity Factor provides a range above and below the calculated value. For example, a duration array with an ASF of 0.2% means that a calculated value+0.1% or −0.1% would fall within the acceptable range for a match for that policy instance. So in the evaluation process, the ASF is multiplied by 50% and the absolute difference of the value between the reported value and the policy instance value is used in the comparison.
This process can be varied in the embodiments. In theory, a calculation can never project above the limit made possible by the interest rate applied. The range is expected to anticipate rounding errors and small deviations in calculation per the carrier which are more likely to create errors on the bottom end of the projection.
A nonexclusive example of variation may include Value+0.20% or Value−0.80% of the CALC Adjusted Sensitivity Factor. This is applied for all policy instances to create a unique range.
For this evaluation, the process cycles through the vector/array of policy instances in ascending order and does the following:
Compares DTCC Cash Value with the values projected within the duration for that product. Finds the closest match to the reported DTCC Cash Value. This is the ARRAY.Best Match Policy Instance.
Calculates the CALC.Best Fit Policy Instance Variance from the Reported Cash Value and the Projected Cash Value. This is ABS (DTCC Cash Value−ARRAY.Best Match Policy Instance)/DTCC Premium Paid.

$$Calculates the CALC Best Fit Cash Value Range = 1 / {2}^{*} CALC Cash Value Adjusted Sensitivity Factor Calculation for the policy duration array .$$

IF DTCC Cash Value=ARRAY.Policy Instance Cash Value+/−CALC Best Fit Cash Value Range then the policy instance is marked to CONFIRM MATCH. The processing is stopped.
   IF no match is found, the ARRAY status is set to “NO POLICY INSTANCE MATCH”. The processing then continues.
   To validate the policy instance, the instance marked as CONFIRM MATCH is compared to the DTCC Surrender Value with the ARRAY.Projected Surrender Value for that policy instance.
IF the DTCC Surrender Value+/−the CALC Surrender Value Adjusted Sensitivity Factor is in the range of the ARRAY.Projected Surrender Value, the policy instance status is set to “STRONG MATCH”.
ELSE the policy instance status is set to “POSSIBLE MATCH”. Processing continues for the array.

### 6. Special Cases

IF No Match is the status for the Range Matching AND the lowest possible value for projected cash value is higher than DTCC Cash Value, the policy instance is set to “Active Policy—Policyholder Withdrawal”.
If NO MATCH is found for the Adjusted Sensitivity Matching Algorithm AND the lowest possible value within the duration array is greater than the DTCC Cash Value, the policy instance is set to “ACTIVE POLICY—WITHDRAWAL INDICATED”.
IF Probable Match is the status and the policy is less than 30 months in duration from the time of issue to DTCC valuation, if the duration is not known this is not dispositive since there will be few differences in surrender charge or surrender charge rate among policy instances.
In this case, the Adjusted Sensitivity Value Matching algorithm is applied to (attempt to) determine a matching policy instance across durations. If one and only one match is found among instances, that policy instance is set to “PROBABLE MATCH” and the policy duration is set to the policy duration for that instance.

### Matching Algorithm Examples

This provide some additional nonexclusive examples of the matching for different types of policies/policy vectors/arrays.

### 7. Known Duration, Zombie Product, Policy Not Zombie

Symetra Select 5
Policy ID SYM-87151W798-P235575748
Issue Date Apr. 1, 2020
Premium Paid $100,000.00
Valuation Date Jan. 1, 2024
Policy Status Not Zombie
Product MGIR @ Issue Date 1%

| | | | Cash | Surrender | Projected | |
|---|---|---|---|---|---|---|
| | | | Value @ | Value @ | Surrender | |
| | | | Valuation | Valuation | Charge | Projected |
| Policy Instance ID | Policy Instance Description | Issue Rate | Date | Date | (minus MVA) | MVA |
| Product Duration | 5 | | | | | |
| 5HIGHDEFY0NNY | 5-Year Mid-High Band No ROP | 2.000% | $107,708.67 | $100,923.02 | 5.12% | $1,064.75 |
| 5HIGHDEFN0NNY | 5-Year Mid-High Band ROP | 1.800% | $106,918.82 | $100,182.94 | 5.09% | $0.00 |

DTCC Cash Value: $107,500
DTCC Surrender Value: $100,850

There is a known duration, so the only determination is made of the product instance. This proceeds as follows:

$$The lowest difference among instances in projected cash value = \$107 , 787.67 - \$106 , 918.72 = \$789 \text{.85} . \qquad 1.$$

$$ASF . \$789 \text{.95} / \$100 , 000 = \text{.790} \% . 50 \% of this range is \text{.394} \% . \qquad 2$$

3. Projected Cash Value+/−0.394% range is:
   a. No ROP product—$107,283-$108,134
   b. ROP Product—$106,496.57-$107,341.07
4. DTCC Reported Cash Value is within the No ROP product range and NOT in the ROP product range so it uniquely matches this policy instance.
5. Validation—ASF calculated for surrender value is 0.74%, 50% of this is 0.37%.
6. No ROP Product Range for surrender charge applying the ASF is is $100,549-$101,296. DTCC Surrender Value ($100,850) is in this range so policy instance is confirmed.

### VALIDATION RESULTS

Duration, 5 Years—STRONG MATCH
Policy Instance—5-Year Mid-High Band No ROP—STRONG MATCH

### 8. Unknown Duration, Zombie Product, Zombie Status

Policy ID WS-959550120-P459284573
Issue Date Jan. 1, 2020
Premium Paid $100,000.00
Valuation Date Feb. 1, 2024
Policy Status Zombie
Product MGIR @ Issue Date 1%

| | | | | Surrender | Projected | |
|---|---|---|---|---|---|---|
| | Policy | | | Value @ | Surrender | |
| | Instance | Issue | Cash Value @ | Valuation | Charge | Projected |
| Policy Instance ID | Description | Rate | Valuation Date | Date | (minus MVA) | MVA |
| Product Duration | 6 | | | | | |
| 5HIGHDEFY0NNY | 5-Year High Band MVA | 2.250% | $109,138.61 | $109,138.61 | 0.00% | $0.00 |
| 5HIGHDEFN0NNY | 5-Year High Band No MVA | 2.200% | $108,978.58 | $108,978.58 | 0.00% | $0.00 |
| Product Duration | 6 | | | | | |
| 6HIGHDEFY0NNY | 6-Year High Band MVA | 2.150% | $110,057.73 | $110,057.73 | 0.00% | $0.00 |
| 6HIGHDEFN0NNY | 6-Year High Band No MVA | 2.100% | $109,842.41 | $109,842.41 | 0.00% | $0.00 |

DTCC Cash Value: $109,000
DTCC Surrender Value: $109,000

A range validation is required first to (try to) determine the duration of the product. The product inforce is a zombie so no surrender charge or MVA exists, so the only applicable validation is the cash value.
1. DTCC Cash Value is in the range of 5-year product cash values ($108,978-$109,138) and BELOW the lowest range value of 6-year products ($109,842). So there is a STRONG MATCH for the 5-year duration.
2. Surrender value is the same as the policy is a zombie so there is no validation there.
   So the range is set at 5-years. Next, determination is made for the policy instance within that range:

$$The lowest difference among instances in projected cash value = \$107 , 787.67 - \$106 , 918.72 = \$160 \text{.03} . \qquad 1.$$

$$ASF . \$160 / \$100 , 000 = \text{.16} \% . 50 \% of this range is \text{.08} \% . \qquad 2$$

3. Projected Cash Value+/−0.394% range is:
   a. MVA Product—$109,051-$109,225
   b. No MVA Product—$108,891-$109,065
4. DTCC Reported Cash Value is within the No MVA product range and NOT in the MVA product range so it uniquely matches this policy instance.

### VALIDATION RESULTS

Duration, 5 Years—STRONG MATCH
Policy Instance—5-Year Mid-High Band No ROP—STRONG MATCH

### 9. Auto-Renewing Policy Unknown Duration

Security Benefit Life Advanced Choice Annuity
Jan. 1, 2018
Policy ID SBL814121166-
Premium Paid $100,000.00
Validation Date Apr. 1, 2024
Policy ID Premium Paid Auto-Renewing
Product MGIR @ Issue Date 1%

| | | | | Surrender | Projected |
|---|---|---|---|---|---|
| | | | | Value @ | Surrender |
| | | Cash Value @ Issue | | Valuation | Charge |
| Policy Instance ID | Policy Instance Description | Rate Valuation Date | | Date | (minus MVA) |
| Product Duration | 3 | | | | |
| 3HIGHDEFY0NNY | 3-Year High Band Interest Only MVA | 2.900% | $121,520.89 | $109,545.62 | 8.87% |
| 3HIGHDEFY0YNN | 3-Year High Band 10% WD MVA | 2.850% | $121,148.24 | $110,227.46 | 8.11% |
| 3HIGHDEFN0NNY | 3-Year High Band Interest Only No M | 2.700% | $119,978.53 | $109,325.69 | 8.88% |
| 3HIGHDEFN10NNN | 3-Year High Band 10% WD No MVA | 2.650% | $120,191.07 | $110,440.70 | 8.11% |
| Product Duration | 5 | | | | |
| 5HIGHDEFY0NNY | 5-Year High Band Interest Only MVA | 3.100% | $121,800.54 | $110,733.87 | 7.65% |
| 5HIGHDEFY0YNN | 5-Year High Band 10% WD MVA | 3.050% | $121,427.16 | $111,045.14 | 7.20% |
| 5HIGHDEFN0NNY | 5-Year High Band Interest Only No MVA | 3.000% | $121,054.75 | $111,780.56 | 7.66% |
| 5HIGHDEFN10NNN | 5-Year High Band 10% WD No MVA | 2.950% | $120,683.31 | $111,994.11 | 7.20% |
| Product Duration | 7 | | | | |
| 7HIGHDEFY0NNY | 7-Year High Band Interest Only MVA | 3.600% | $125,104.62 | $120,718.92 | 3.34% |
| 7HIGHDEFY0YNN | 7-Year High Band 10% WD MVA | 3.550% | $124,722.73 | $120,009.81 | 3.60% |
| 7HIGHDEFN0NNY | 7-Year High Band Interest Only No M | 3.400% | $123,582.95 | $0.00 | 3.20% |
| 7HIGHDEFN10NNN | 7-Year High Band 10% WD No MVA | 3.350% | $123,204.98 | $0.00 | 3.60% |

| | | | | Renewal | | | Renewal |
|---|---|---|---|---|---|---|---|
| | Projected | CV @ | NM Rate | Rate | CV @ | NM Rate | Rate |
| Policy Instance ID | MVA | Renewal 1 | Renewal 1 | Renewal 1 | Renewal 2 | Renewal 2 | Renewal 23 |
| Product Duration | | | | | | | |
| 3HIGHDEFY0NNY | $1,095.46 | $109,334.00 | 2.30% | 2.30% | $118,435.00 | 4.40% | 4.40% |
| 3HIGHDEFY0YNN | $1,102.27 | $109,178.00 | 2.25% | 2.25% | $118,109.00 | 4.30% | 4.30% |
| 3HIGHDEFN0NNY | $0.00 | $108,877.00 | 2.20% | 2.20% | $117,845.00 | 4.20% | 4.20% |
| 3HIGHDEFN10NNN | $0.00 | $108,445.00 | 2.15% | 2.15% | $117,334.00 | 4.15% | 4.15% |
| Product Duration | | | | | | | |
| 5HIGHDEFY0NNY | $2,214.68 | $117,995.00 | 2.65% | 2.65% | | | |
| 5HIGHDEFY0YNN | $2,220.90 | $117,445.00 | 2.60% | 2.60% | | | |
| 5HIGHDEFN0NNY | $0.00 | $117,032.00 | 2.50% | 2.50% | | | |
| 5HIGHDEFN10NNN | $0.00 | $116,884.00 | 2.45% | 2.45% | | | |
| Product Duration | | | | | | | |
| 7HIGHDEFY0NNY | $603.59 | | | | | | |
| 7HIGHDEFY0YNN | $600.05 | | | | | | |
| 7HIGHDEFN0NNY | $0.00 | | | | | | |
| 7HIGHDEFN10NNN | $0.00 | | | | | | |

DTCC Cash Value: $121,300
DTCC Surrender Value: $111,000
CALC Surrender Charge: 7.5%

A range validation is required first to (try to) determine the duration of the product. Given the duration of the inforce product and available ranges, the 3-year product has auto-renewed twice, the 5-year product has auto-renewed once, and the 7-year product has 9 months remaining in the initial guarantee period.
The range validation proceeds as follows:
1. The DTCC Cash Value falls within the cash value range of both the 3-year and the 5-year product. Both ranges are set to POSSIBLE MATCH.
2. The DTCC Surrender Value falls uniquely within the 5-year product range, which is set to STRONG MATCH.
3. To validate, the calculated surrender charge of 7.5% falls within the projected surrender range of the 5-year product, confirming the duration.
   With the duration set, the next step is to (try to) match the policy instance. First step is to calculate the ASF for the cash value and surrender values of the 5-year policy array:

Cash Value Delta ASF

| | | |
|---|---|---|
| $121,800.54 | | |
| $121,427.16 | $373.37 | |
| $121,054.75 | $372.41 | |
| $120,683.31 | $371.45 | 0.3714% |

Surrender Value Delta ASF

| | | |
|---|---|---|
| $110,733.87 | | |
| $111,045.14 | ($311.27) | |
| $111,780.56 | ($735.42) | |
| $111,994.11 | ($213.55) | −0.2135% |

For this the DTCC Cash Value is determined within +/−0.1857% of a projected value. The 5-Year High Band Interest Only with MVA value $121,427-$225.52 (0.1857%×$121,427=$121,201 so the value falls within this range. The next lower range, $121,054+$225.52=$121,279 is less than the DTCC Cash Value.
So the 5-Year High Band Interest Only with MVA product is a STRONG MATCH.
This is validated by confirming that the DTCC Surrender Value falls within the projected surrender value range ($111,045+/−$213.55). It does, so this confirms that STRONG MATCH for this policy instance.

### VALIDATION RESULTS

Duration, 5 Years—STRONG MATCH
Policy Instance—5-Year High Band Interest Only with MVA—STRONG MATCH

Numerous variations are possible in the foregoing. Although specific calculations and processes are described in the embodiments, those calculations and processes are nonexclusive. Variations may include large language model (LLM) and other artificial intelligence (AI) analyses, which may be performed by the systems and methods or other elements. Although results of the systems and processes appear valid, additional, substitute, or similar steps and elements may be employed in the embodiments. Further validations are possible in the embodiments. Various carriers have different terms for policy products, and variations in the embodiments can correspond to those terms and products.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and device(s), connection(s) and element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system, comprising:
a processor;
memory communicatively connected to the processor, wherein the memory includes instructions for controlling the processor to:
obtain raw data of annuity products;
write the raw data to a rules table of respective files communicatively connected to the processor;
select one or more of the respective files of the rules table corresponding to a request;
compose a vector comprised of the one or more of the respective files, each annuity product exhibited by the one or more respective files is a respective policy instance;
calculate a respective cash value and a respective surrender value of each of the respective policy instance of the vector based on the raw data;
calculate a projected respective cash value and a projected respective surrender value for each of the respective policy instance of the vector; and
match any of the respective policy instance to the request based on the respective cash value, the respective surrender value, the projected respective cash value, and the projected respective surrender value; and
calculate a duration for any of the respective policy instance matched in the match.

2. The system of claim 1, further comprising:
the instructions for controlling the processor include;
report the duration, the projected respective cash value, and the projected respective surrender value.

3. A method, comprising:
obtaining raw data of annuity products;
writing the raw data to a rules table of respective files;
selecting one or more of the respective files of the rules table;
building a vector of the one or more of the respective files, each annuity product exhibited by the one or more respective files is a respective policy instance;
calculating a respective cash value and a respective surrender value of each of the respective policy instance of the vector based on the raw data;
calculating a projected respective cash value and a projected respective surrender value for each of the respective policy instance of the vector;
matching any of the respective policy instance to the request based on the respective cash value, the respective surrender value, the projected respective cash value, and the projected respective surrender value; and
calculating a duration for any of the respective policy instance matched in the match.

4. The method of claim 3, further comprising:
reporting the duration, the projected respective cash value, and the projected respective surrender value.
